(19) United States
(12) Patent Application Publication
(10) Pub. No.: US 2005/0076351 A1
(43) Pub. Date: Apr. 7, 2005

(54) Pick-up head for an optical recording/reproducing instrument

(76) Inventors: Hsiu-Wen Tang, Taipei (TW); Chun-Ming Chen, Pan Chiao City (TW)

Correspondence Address: RABIN & Berdo, PC, 1101 14TH STREET, NW, SUITE 500, WASHINGTON, DC, 20005, US

(21) Appl. No.: 10/951,721

(22) Filed: Sep. 29, 2004

(30) Foreign Application Priority Data
Oct. 3, 2003 (TW) 92127423

(51) Int. Cl. G11B 13/00; G11B 33/14; G11B 7/08; G11B 7/085; G11B 7/09

(52) U.S. Cl. 720/649; 720/672

(57) ABSTRACT

A pick-up head for an optical recording/reproducing instrument includes a carriage seat and a flexible printed circuit disposed on the carriage seat. A heat conductive member is fitted within a through hole in the flexible printed circuit to facilitate downward flow of air via the heat conductive member in order to enhance the heat dissipating effect.

### FIELD OF THE INVENTION

The invention relates to a pick-up head, more particularly to a pick-up head for an optical recording and/or recording instrument provided with a control chip set and a heat conductive member disposed below the control chip set so as to enhance the heat dissipating effect of the pick-up head.

### BACKGROUND OF THE INVENTION

The advent of personal computer production consequently brings improvements to the peripheral devices. The computer peripheral devices, such as optical recording/reproducing instruments, hard drives, image scanners, and printers are widely used not only in offices, but also at homes due to their low costs. The optical recording/reproducing instrument, such as a DVD player, is most common, and is appreciated by the consumer due to its large storage space and since the data can be stored in an optical disk in image or music modes for a long period of time. A DVD (digital versatile disc) of the latest development has 17GB storage capacity, possesses high transmission characteristics, and causes wide utility of the DVD player by the consumers.

Referring to FIG. 1, a conventional DVD player is shown to include a transverse module 5, a spindle motor 10, a disk loader 12 mounted on the spindle motor 10, an optical disk (not shown) mounted on the disk loader 12 so as to be rotated by the spindle motor 10, a guiding rail 17 mounted on the transverse module 5, a carriage seat 15 slidably mounted on the rail 17, and a pick-up head 14 mounted on the carriage seat 15.

Referring to FIG. 2, the pick-up head 14 of the conventional optical recording/reproducing instrument includes a bottom member 141, an optical element (not shown), a laser diode (not shown), an actuator 142 disposed below the bottom member 141, a control chip set 143, a plastic reinforced plate 144 and a flexible printed circuit (FPC) 145. The carriage seat 15 is movable on the rail 17 upon actuation of a sled motor 18, which in turn, causes the pick-up head 14 to move horizontally on the transverse module 5. The pick-up head 14 is provided with a voice coil motor. The flexible printed circuit 145 is disposed above the reinforced plate 144 such that the former spreads over outer and lateral surfaces of the bottom member 141. The control chip 43 is soldered securely onto the flexible printed circuit 145 by SMT (surface mount technology). coil motor (not shown), which cooperates with the sled motor 18 to enable the pick-up head 14 to move downward and upward along the vertical direction with respect to the transverse module 5 in order to precisely focus the laser beam on a recording surface of the optical disk, thereby permitting reading/writing operation of the data from front, rear, upward and downward positions of the optical disk. The plastic reinforced plate 144 is disposed on the bottom member 141 to provide support to the flexible printed circuit 145 such that the flexible printed circuit 145 covers upper and lateral surfaces of the bottom member 141 so as to establish electrical communication with the corresponding elements. The control chip set 143 is attached on the flexible printed circuit 145 by means of SMT (Surface Mount Technology). A heat sink 147 is disposed above the flexible printed circuit 145 in order to dissipate heat generated during operation of the conventional DVD player.

An important aspect to note is that as the reading rate or data recording rate is increased, the rotation speed of the spindle motor 10, the sled motor 18 and the voice coil motor subsequently hasten, thereby generating intensive heat within the DVD player. A cooling fan is generally installed in the conventional DVD player in order to dissipate the intensive heat therefrom.

For an optical recording/reproducing instrument, the aforesaid cooling fan can provide a limited heat dissipating effect to the current pick-up head 14 due to presence of the voice coil motor, the integrated circuit chip, the laser diode, and the optical components, which are subjected to generate heat. DVD

Once the aforesaid components are under fast operation during the reading of the optical disk, the pick-up 14 moves swiftly via the voice coil motor so as to enable the integrated circuit to execute a large amount of data transmission, thereby resulting in high temperatures within an outer casing of the pick-up head 14. There may occur incorrect reading operation of the pick-up head 14. Since high efficient laser beams are used in order to record the data on the optical disk, the heat dissipation problem thereof is aggravated.

FIG. 3 is a partly sectional view of the pick-up head 14 of the conventional DVD player. Note that provision of the reinforced plate 144 below the flexible printed circuit 145 though provides a rigidity support to the flexible circuit 145, however, blocks the downward flow of air, which hinders the head dissipating effect of the pick-up head 14.

### SUMMARY OF THE INVENTION

The object of the present invention is to provide a pick-up head for an optical recording and/or recording instrument which includes a heat conductive member mounted within a reinforced plate that supports a flexible printed circuit so as to enhance the heat dissipating effect of the pick-up head.

According to the present invention, an optical recording/reproducing instrument is provided to include: a guiding rail unit, and a pick-up head mounted slidably on the guiding rail unit. The pick-up head includes: a carriage seat, a FPC (flexible printed circuit) disposed on the carriage seat and having a through hole formed therethrough, a heat conductive member fitted within the through hole in the flexible printed circuit, and a control chip set soldered on the flexible printed circuit in such a manner that the control chip set overlaps the heat conductive member.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view, illustrating relationship of a pick-up head and a transverse module in a conventional optical recording/reproducing instrument;

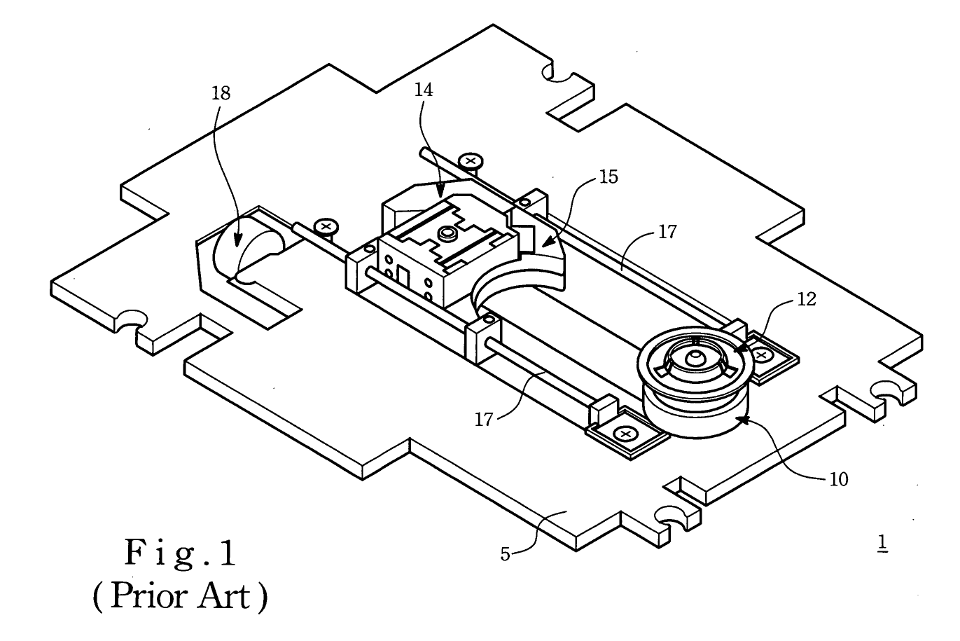

FIG. 2 is an exploded perspective of the pick-up head in the conventional optical recording/reproducing instrument;

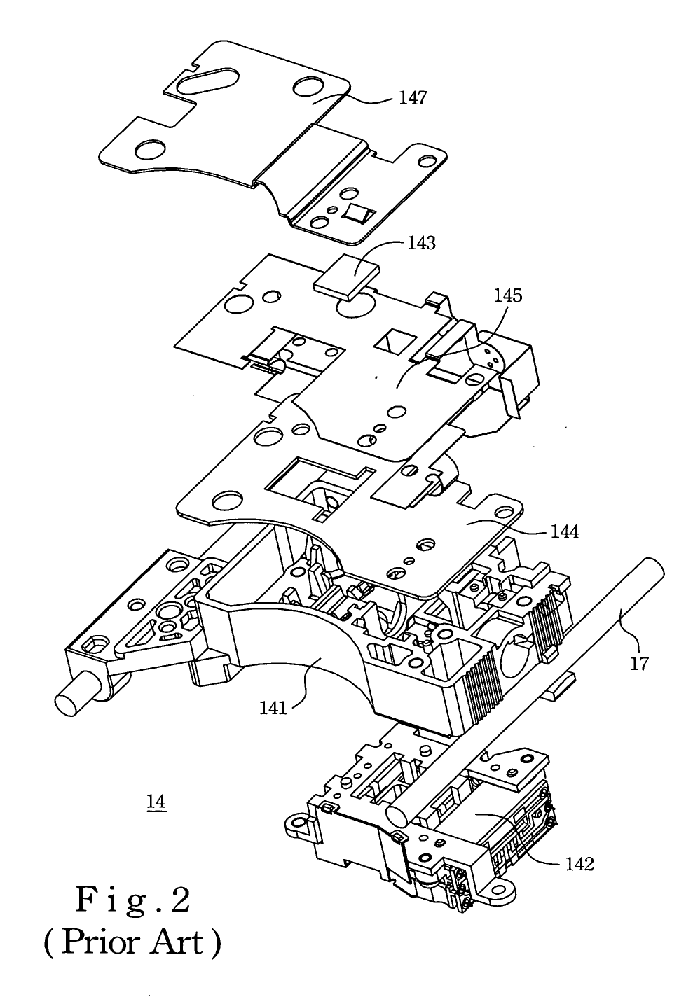

FIG. 3 is a partly sectional view of the pick-up head in the conventional optical recording/reproducing instrument;

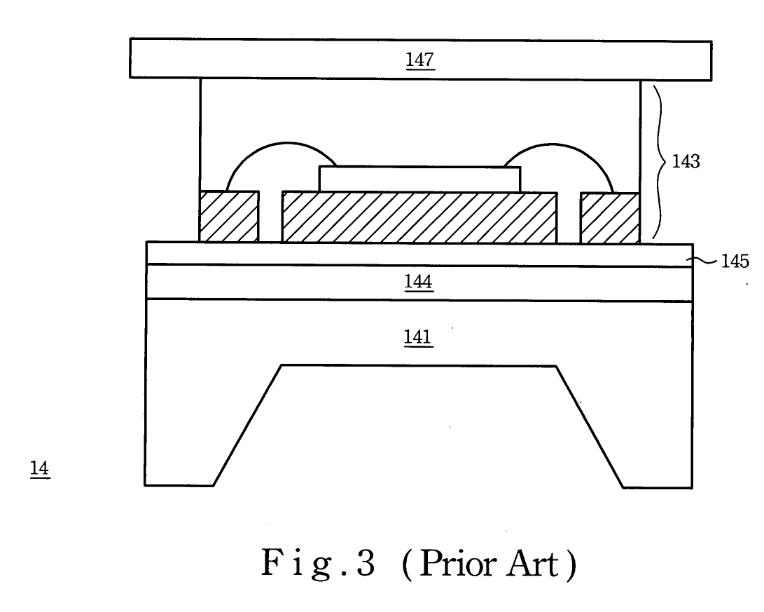

FIG. 4 is an exploded and perspective view of a pick-up head of the preferred embodiment of an optical recording/reproducing instrument in accordance with the present invention;

FIG. 5 is a partly sectional view of the pick-up head in the preferred embodiment of an optical recording/reproducing instrument in accordance with the present invention;

FIG. 6 is a partly sectional view of a modified pick-up head in the preferred embodiment of an optical recording/reproducing instrument in accordance with the present invention.

### DETAILED DESCCRIPTIONS OF THE PREFERRED EMBODIMENTS

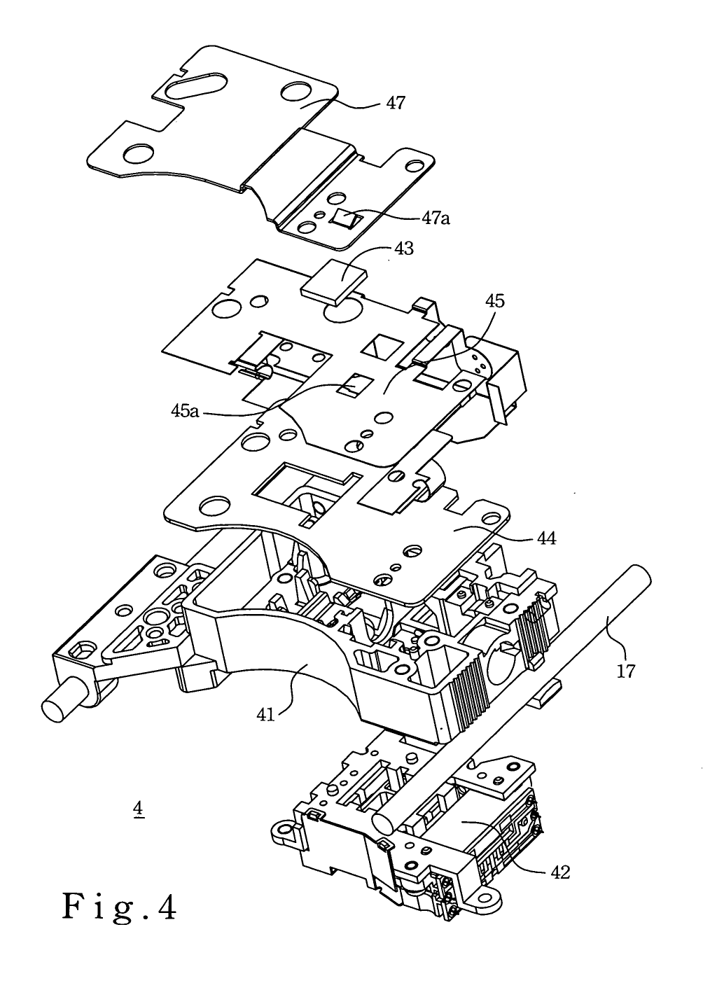

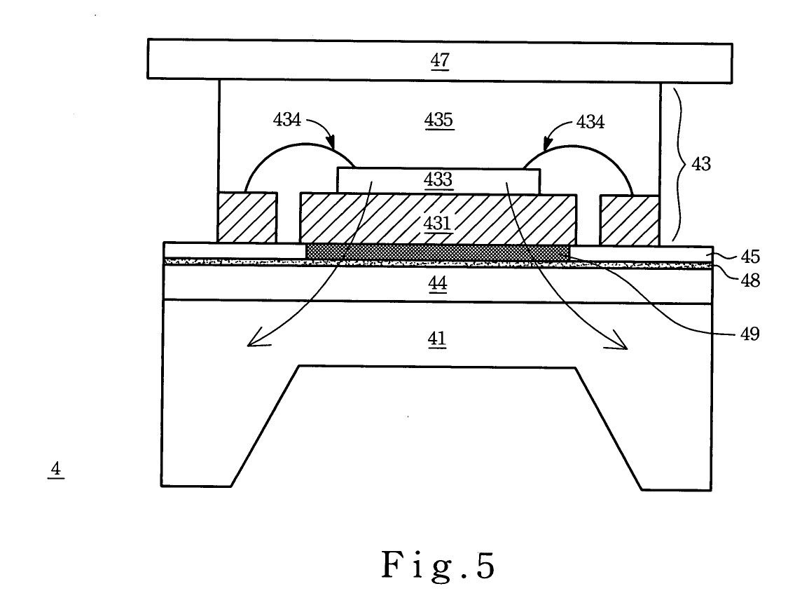

Referring to FIGS. 4 and 5, the preferred embodiment of an optical recording/reproducing instrument (such as a DVD player) is shown to include a pick-up head 4 and a heat sink 47. The pick-up head 4 includes a carriage seat 41, an optical component (not shown), a laser diode (not shown), a voice coil motor 42, a control chip 43, a reinforced plate 44, and a flexible printed circuit (FPC) 45. The carriage seat 41 is loaded with the optical component, and has two opposite lateral sides 41 sleeved movably on two stationary rails 17 of a guiding rail unit in the DVD casing (not shown).

The voice coil motor 42 is disposed below the carriage seat 41 for moving the latter horizontally and vertically relative to the rails 17 during the reading or recording operation of the optical disk. The laser diode is provided on the carriage seat 41 in such a manner to emit laser beams onto an optical disk (not shown) along a predetermined angle in order to read the data thereon or for recording data onto the optical disk. Since the structure of the pick-up head 4 is not the relevant feature of the present invention, a detailed description thereof is omitted herein for the sake of brevity.

The flexible printed circuit 145 is disposed on the carriage seat 41 and spreads over outer and lateral surfaces of the carriage seat 41. The reinforced plate 44 is disposed between the flexible printed circuit 45 and the carriage seat 41 in order to provide support to the flexible printed circuit 45. The heat conductive member 49 is fitted within the through hole 45a in the flexible printed circuit 45. The control chip 43 is soldered securely onto the flexible printed circuit 45 by SMT (surface mount technology) in such a manner to overlap the heat conductive member 49 due to the vertical alignment thereof. The reinforced plate 44 can be made from metal material or other materials so long as it can provide rigidity to the flexible printed circuit 45 200. The reinforced plate 44 is made from a metal group consisting of aluminum, brass, and zinc. The heat conductive member 49 is selected from a group consisting of tin(Sn), tin(Sn) solder paste, a chemical compound including nickel or tin or lead, and heat conductive paste. In order to enhance the heat dissipating effect of the pick-up head 4, a solder mask 48 is disposed between the heat conductive member 49 and the reinforced plate 44. The solder mask 48 can be made from a metal group consisting of nickel and lead. In the event the heat conductive member 49 and the reinforced plate 44 are made from tin and aluminum, provision of the solder mask 48 between the heat conductive member 49 and the reinforced plate 44 enables fast bonding effect between the solder mask 48 the heat conductive member 49. Alternatively, in the event the heat conductive member 49 is made from heat-conductive plastic or heat-conductive solder paste, the solder mask 48 can be deleted. Under this condition, the reinforced plate 44 can also be made from brass or zinc or a combination of both.

The heat sink 47 is disposed above the flexible printed circuit 45, covers the control chip 43, and has a plurality of mounting holes. A plurality of fasteners (not shown) extend through the mounting holes in the heat sink 47 for fastening the carriage seat 41. The heat sink 47 has a plurality of protrusions (47a) (only one is visible in FIG. 4) projecting upwardly from an upper surface thereof. Each of the protrusions (47a) is in the form of a fin configuration. The control chip set 43 preferably includes a chip-supporting pad 431 having a plurality of circuits 434, a bottom surface formed with a plurality of lower solder spots (not visible) for electrical communication with the flexible printed circuit 45, and an upper surface formed with a plurality of upper solder spots. A chip element 433 is disposed above the chip-supporting pad 431 and is electrically connected to a respective one of the upper solder spots via a selected one of the circuits 434. A protective shield 435 is disposed above the chip-supporting pad 433 in such a manner to cover the chip element 433 and the circuits 434. Note that the protrusions 47a on the heat sink 47 are arranged downstream to the air flow direction of the suction fan (not shown) that is generally installed within the DVD casing in order to dissipate the heat generated due to operation of the DVD player. Since the air of the suction fan flows back toward the flexible printed circuit 45 after colliding the protrusions 47a of the heat sink 47, the temperatures of those electronic parts (not shown) that are mounted on the flexible printed circuit 45 can be lowered. In addition, the heat dissipating effect of the DVD player is consequently increased due to the presence of the reinforced plate 44, the solder mask 48 and the heat conductive member 49 and due to the downward flow of the air in the arrow direction (see FIG. 5).

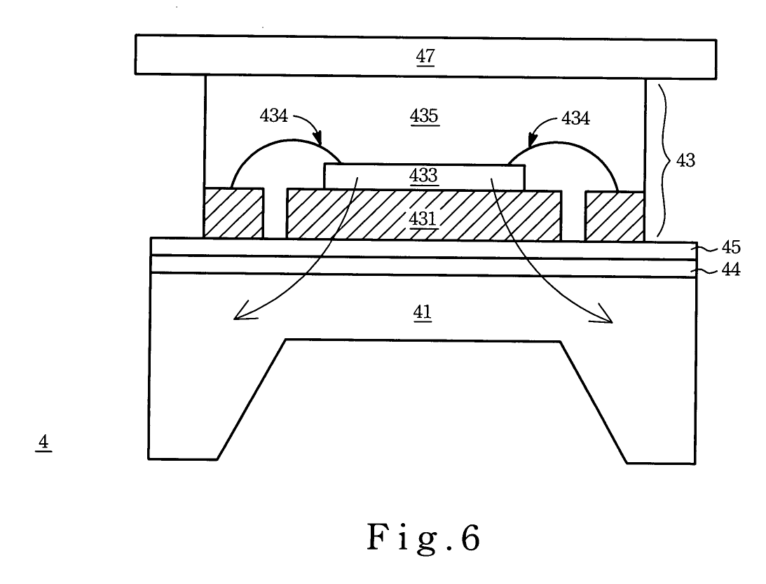

Referring to FIG. 6, a modified pick-up head of the preferred embodiment of a DVD player according to the present invention is shown to have a construction similar to the previous embodiment. Except the solder mask 48 is deleted and there is no heat conductive member 49 within the flexible printed circuit 44. The heat can be dissipated as shown in the arrow direction since the reinforced plate 44 is made from metal.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A pick-up head for an optical recording/reproducing instrument, comprising:
a carriage seat;
a FPC (flexible printed circuit) disposed on said carriage seat, and having a through hole formed therethrough;
a heat conductive member fitted within said through hole in said flexible printed circuit; and
a control chip set soldered on said flexible printed circuit in such a manner that said control chip set overlaps said heat conductive member.

2. The pick-up head for an optical recording/reproducing instrument according to claim 1, wherein said heat conductive member is selected from a group consisting of tin(Sn), tin(Sn) solder paste, metal and heat-conductive paste.

3. The pick-up head for an optical recording/reproducing instrument according to claim 1, further comprising a reinforced plate disposed on said carriage seat so as to provide support to said flexible printed circuit.

4. The pick-up head for an optical recording/reproducing instrument according to claim 1, further comprising a solder mask disposed between said heat conductive member and said reinforced plate.

5. The pick-up head for an optical recording/reproducing instrument according to claim 4, wherein said solder mask is selected from a group consisting of nickel and lead.

6. The pick-up head for an optical recording/reproducing instrument according to claim 1, wherein said control chip set includes a chip-supporting pad having a plurality of circuits, a bottom surface formed with a plurality of lower solder spots for electrical communication with said flexible printed circuit, and an upper surface formed with a plurality of upper solder spots; a chip element disposed above said chip-supporting pad and electrically connected to a respective on of said upper solder spots via a selected one of said circuits, and a protective shield disposed above said chip-supporting pad in such a manner to cover said chip element and said circuits.

7. The pick-up head for an optical recording/reproducing instrument according to claim 1, further comprising a heat sink disposed above said control chip set in order to enhance heat dissipating effect thereof.

8. The pick-up head for an optical recording/reproducing instrument according to claim 6, wherein said through hole in said flexible printed circuit is vertically aligned with said chip-supporting pad.

9. An optical recording/reproducing instrument comprising:
a guiding rail unit; and
a pick-up head mounted slidably on said guiding rail unit, and including
a carriage seat,
a FPC (flexible printed circuit) disposed on said carriage seat, and having a through hole formed therethrough,
a heat conductive member fitted within said through hole in said flexible printed circuit, and
a control chip set soldered on said flexible printed circuit in such a manner that said control chip set overlaps said heat conductive member.

10. The optical recording/reproducing instrument according to claim 9, further comprising a reinforced plate disposed on said carriage seat so as to provide support to said flexible printed circuit.

11. The optical recording/reproducing instrument according to claim 10, wherein said reinforced plate is made from metal material.

12. The optical recording/reproducing instrument according to claim 10, wherein said heat conductive member is made from metal material.

13. The optical recording/reproducing instrument according to claim 10, wherein said heat conductive member is selected from a group consisting of tin(Sn), tin(Sn) solder paste, metal, and heat-conductive paste.

14. The optical recording/reproducing instrument according to claim 10, wherein said control chip set includes a chip-supporting pad having a plurality of circuits, a bottom surface formed with a plurality of lower solder spots for electrical communication with said flexible printed circuit, and an upper surface formed with a plurality of upper solder spots; a chip element disposed on said chip-supporting pad and electrically connected to a respective on of said upper solder spots via a selected one of said circuits, and a protective shield disposed above said chip-supporting pad in such a manner to cover said chip element and said circuits.

15. The optical recording/reproducing instrument according to claim 10, further comprising a heat sink disposed above said control chip set in order to enhance heat dissipating effect thereof.

16. A pick-up head for an optical recording/reproducing instrument, comprising:
a carriage seat;
a metal reinforced plate disposed above said carriage seat;
a FPC (flexible printed circuit) disposed on said carriage seat; and
a control chip set soldered on said flexible printed circuit.

17. A pick-up head for an optical control chip set includes a chip-supporting pad having a plurality of circuits, a bottom surface formed with a plurality of lower solder spots for electrical communication with said flexible printed circuit, and an upper surface formed with a plurality of upper solder spots; a chip element disposed on said chip-supporting pad and electrically connected to a respective on of said upper soldered spots via a selected one of said circuits, and a protective shield disposed above said chip-supporting pad in such a manner to cover said chip element and said circuits.
